(19) United States
(12) Patent Application Publication
(10) Pub. No.: US 2012/0032796 A1
(43) Pub. Date: Feb. 9, 2012

(54) SEPARATION ALARM

(76) Inventors: Philip Anthony Jarrett, West Midlands (GB); Andrew Baird, London (GB)

(21) Appl. No.: 13/264,578

(22) PCT Filed: Apr. 16, 2010
(86) PCT No.: PCT/GB2010/050637

§ 371 Date: Oct. 14, 2011

(30) Foreign Application Priority Data
Apr. 17, 2009 (GB) 0906606.9
Jan. 14, 2010 (GB) 1000568.4

(51) Int. Cl. G08B 1/08

(52) U.S. Cl. 340/539.11

(57) ABSTRACT

A separation alarm, comprising a mobile telecommunication device (1) and a tag (2); the mobile telecommunication device comprising: a receiver (10), which is able to receive signals transmitted by the tag (2); a range calculator (12), which is able to determine, from the signals received from the tag (2), the range of the tag (2) from the mobile telecommunication device (1) to generate a range signal, and compare the range to a predetermined range limit; and an alarm device (4, 6), arranged to emit an alarm on instruction by the range calculator (12); the tag (2) comprising a transmitter (7) arranged to transmit signals to the mobile telecommunication device (1); in which the range calculator (12) is arranged to cause the alarm device (4, 6) to emit an alarm should the range indicated by the range signal exceed the range limit. Typically, the mobile telecommunications device (1) or the tag (2) is arranged to capture and optionally store, as part of the alarm being emitted, sound or video occurring in its vicinity.

This invention relates to a separation alarm.

It is often desired to be alerted when one's valued possessions or even one's dependents are unexpectedly separated from oneself. The spectre of child abduction is never far from a parent's mind, and it is generally desired to provide parents with some peace of mind. There have even been some serious data security alerts caused by the unintentional leaving on trains of laptop computers on which confidential information was stored.

Alarms have been proposed (for example, in GB 2 447 459) which sound should a tag be separated from a base station by more than a predetermined limit; however, these are cumbersome, as the base station must be transported by a user.

According to a first aspect of the invention, there is provided a separation alarm, comprising a mobile telecommunication device and a tag; the mobile telecommunication device comprising:
a receiver, which is able to receive signals transmitted by the tag;
a range calculator, which is able to determine, from the signals received from the tag, the range of the tag from the mobile telecommunication device to generate a range signal, and compare the range to a predetermined range limit;
and an alarm device, arranged to emit an alarm on instruction by the range calculator;
the tag comprising a transmitter arranged to transmit signals to the mobile telecommunication device;
in which the range calculator is arranged to cause the alarm device to emit an alarm should the range indicated by the range signal exceed the range limit.

Thus, a user can use their mobile telecommunication device, such as their (now ubiquitous) mobile phone, to warn if the tag, and accordingly whatever the tag is attached to, is separated from them by more than the predetermined range limit. Accordingly, the tag can be attached to anything of importance to the user; be it a child, a valuable portable item such as a laptop computer or anything else the user would not want to become separated from. Because mobile telecommunication devices are typically carried about the person, the user will not need to carry an extra alarm device in order to be warned should the tagged object or person become separated from the user.

Preferably, the range calculator is also arranged to determine, from the signals transmitted by the tag, the bearing of the tag relative to the mobile telecommunication device. Accordingly, the mobile telecommunication device may be provided with an output for providing information to the user, in which the range calculator is arranged to cause the output to output the bearing of the tag relative to the mobile telecommunication device. Typically, the output will comprise a visual display, but the output could also comprise an audible output.

Where the output comprises a visual display, the mobile telecommunication device may be arranged to display the current location of the tag on the visual display. The mobile telecommunication device may be arranged to show, on the display, the location of the tag by indicating the range and bearing of the tag, or by displaying the location of the tag on a map. The map may be a graphical map, in which the locality is indicated using illustrations, or a map using photographs of the locality. Ideally, the map is updated in real time; it is advantageous that the user be able to see what is actually happening in real time at the location of the tag.

Furthermore, the range calculator may be arranged to cause the alarm device to emit an alarm should the signals from the tag not be received. Thus, this provides a backup for determining whether the tag is unduly separated from the mobile telecommunication device; one cause of signals not being received is likely to be the tag being so far from the mobile telecommunication device that the signals cannot be received, or that something (for example, the walls of buildings or the body of a vehicle) is shielding the signals. It also provides a failsafe way of detecting if the tag is not working, for example due to a low battery, such that the user can be alerted to this error before an unnoticed separation occurs.

The tag may be arranged to indicate, in the signals transmitted by it, whether a fault condition exists in the tag; for example, the fault condition may comprise at least one of:
where the tag comprises a battery powering the tag, low charge in the battery; and
an attempt to tamper with the tag or to remove it from the object to which it has been attached.

In such a case, the range calculator may be arranged to cause the alarm device to emit an alarm should the signals received from the tag indicate a fault condition.

The tag may therefore comprise a detection circuit arranged to determine whether the tag is attached to an object; if the detection circuit determines that the tag becomes detached, then the tag may be arranged to transmit an indication of a fault condition.

The mobile telecommunications system and the tag may each be provided with a location determination device arranged to determine the position of the mobile telecommunication device or the tag respectively; a typical example of such a device would be a Global Positioning System (GPS) device. In such a case, the tag may be arranged to determine its location using its location determination device and to transmit in the signal its location. The range determination device may be arranged to compare the location of the tag as received in the signals with the location of the mobile telecommunication device as determined from its location determination device in order to determine the range of the tag relative to the mobile telecommunication device, and also possibly the relative bearing thereof.

The mobile telecommunication device may comprise a tag transmitter, whereby a query signal can be sent to the tag. The tag may be arranged to rebroadcast the query signal in the signal transmitted by the tag. The range calculator may be arranged to determine the range of the tag from the mobile telecommunication device by determining the time of flight or phase change of the query and received signals. Alternatively, the range calculator may be arranged to determine the range of the tag from the mobile telecommunication device by determining the amplitude of the received signal.

The signals transmitted by the tag and received by the mobile telecommunication device may be those according to a personal area network, such as that according to the Bluetooth standard.

The mobile telecommunication device may be a mobile telephone or a personal data assistant (PDA). The range calculator may comprise a microprocessor of such a device; typically, the microprocessor will be that microprocessor in the mobile telecommunication device that carries out general purpose processing for the mobile telecommunication device's telecommunications functions.

The tag may comprise an input device, such as a button, such that activation of the button causes the tag to send in the signals a signal to the mobile telecommunication device so as to cause the range processor circuit to cause the alarm device to emit an alarm. This is useful if the user has possession of the tag, but not the telecommunications device.

Additionally or alternatively, the alarm device may be arranged to run an application on the mobile telecommunications device in order to emit an alarm. The application may send a message using telecommunications features of the mobile telecommunications devices; for example, a message such as a short message service (SMS) text message, a picture message (multimedia messaging service or MMS) or voice message, or a telephone call may be placed to a predetermined telephone number. Also, the mobile telecommunications device or the tag may be arranged to capture or cause to be captured, and to optionally store, as part of the alarm being emitted, sound or video occurring in its vicinity; the tag may be arranged to transmit captured sound or video back to the mobile telecommunications device.

The choice of which application or other alarm (for example, visual or audible) used to emit the alarm may be set by the user in the mobile telecommunications device. As such, the mobile telecommunications device may comprise memory in which is stored the choice of alarm.

According to a second aspect of the invention, there is provided a mobile telecommunication device comprising:
a receiver, which is able to receive signals transmitted by a tag;
a range calculator, which is able to determine, from the signals received from the tag, the range of the tag from the mobile telecommunication device to generate a range signal;
and an alarm device, arranged to emit an alarm on instruction by the range calculator;
in which the range calculator is arranged to cause the alarm device to emit an alarm should the range indicated by the range signal exceed the range limit.

The mobile telecommunication device may have any of the optional features of the mobile telecommunication device of the first aspect of the invention; indeed, it may be used as the mobile telecommunication device of the separation alarm of the first aspect of the invention.

According to a third aspect of the invention, there is provided software which, when loaded onto a suitable mobile telecommunication device, causes it to act as the mobile telecommunication device of the second aspect of the invention.

Accordingly, this provides useful software that can be installed on a mobile telecommunication device so as to enable it to be used in a separation alarm according to the first aspect of the invention.

According to a fourth aspect of the invention, there is provided a method of manufacture of a mobile telecommunication device for use in the separation alarm of the first aspect of the invention or according to the second aspect of the invention, comprising providing a mobile telecommunication device and loading onto that device the software according to the third aspect of the invention.

There now follows, by way of example only, embodiments of the present invention, described with reference to the accompanying drawings, in which:

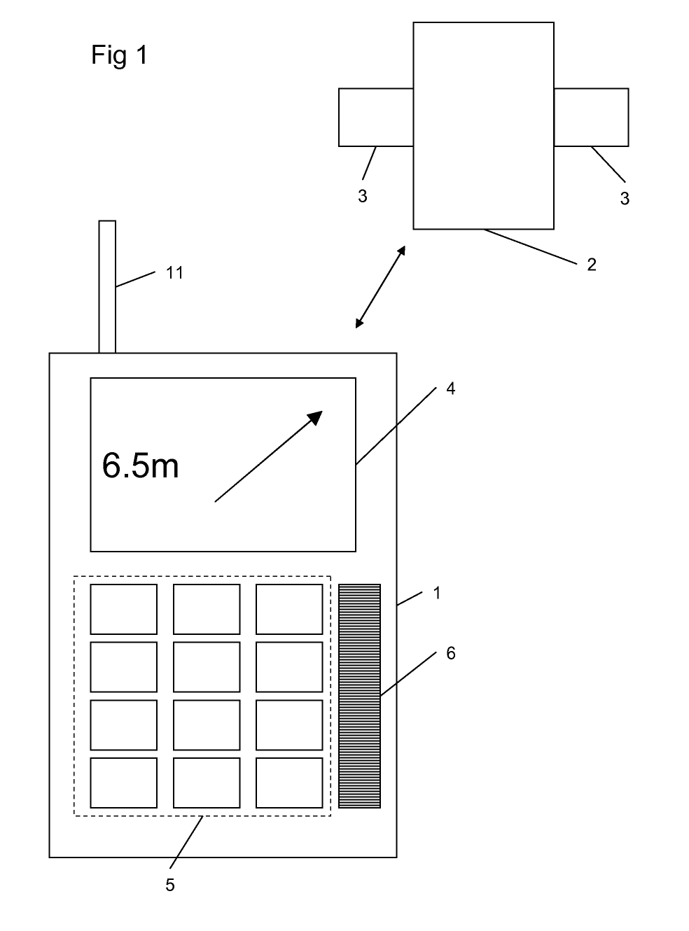

FIG. 1 shows schematically a separation alarm according to an embodiment of the invention; and

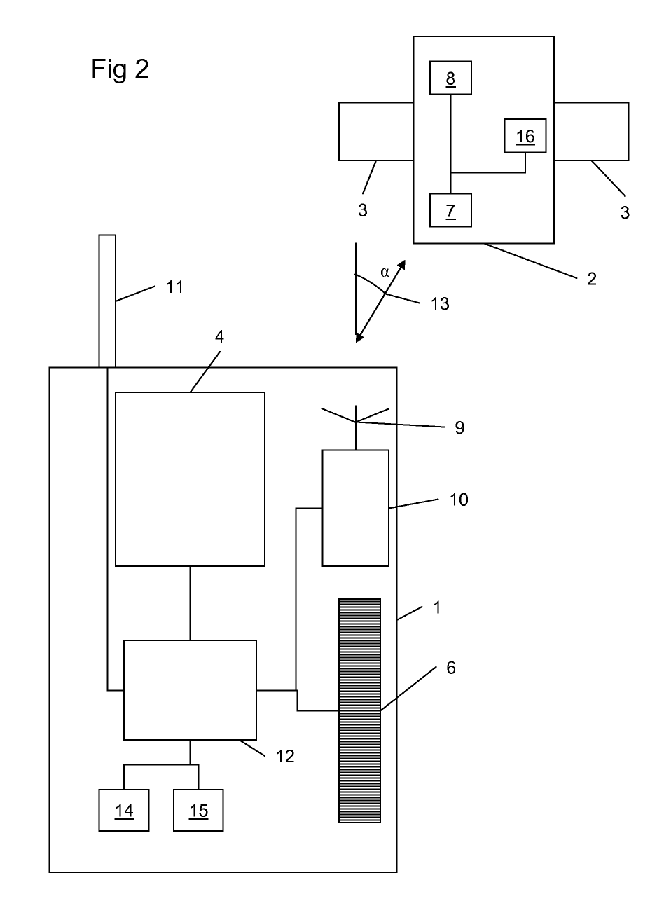

FIG. 2 shows schematically the functional components of each of the integers of the separation alarm of FIG. 1.

The separation alarm shown in FIG. 1 comprises two main components; a mobile telecommunication device being a mobile telephone 1, and a tag 2. The mobile telephone can be any common mobile telephone, adapted to provide the functionality described below; the tag is of a suitable size to be attached to an object from which a user wishes not to be separated. In the present embodiment, the tag 2 is shown with a wristband 3 such that the tag 2 can be worn on the wrist of a small child (of the age of about three years) but the tag 2 could equally well be attached to any other object of value, for example a laptop computer, keys, handbag, wallet, clothes, suitcases or so on.

The mobile telephone 1 has an output device comprising a display 4, an input device comprising a plurality of input buttons 5 and a speaker 6, as will be familiar to most users of mobile telephones.

In order to provide an alarm on separation of the tag (carried by the child or object of value) from the mobile telephone (carried by the user), the tag 2 continually sends a signal using transmitter 7 to the mobile telephone 1. The transmitter 7 is powered by a battery 8 in the tag 2. The battery can be rechargeable via an external charging socket (not shown; typically of the form of a USB socket or a DC-in coaxial socket), or may be non-rechargeable and simply replaced when necessary. This signal is received by the mobile telephone 1 using auxiliary antenna 9, and receiver 10; in this embodiment, the auxiliary antenna 9 is a different antenna to the main antenna 11 used by the mobile telephone for communication with mobile telecommunication networks.

The receiver 10 passes the received signal to a range calculating circuit 12; typically, this would be the general purpose microprocessor running the mobile telephone. The range calculating circuit 12 determines from the signal the range 13 and the bearing a from the tag 2 to the mobile telephone 1. Should the range exceed a predetermined limit (which can be stored in a memory 14 of the mobile telephone and can be set by a user using the input buttons 5), the range detection circuit can cause an alarm to be emitted.

This alarm is both audible, from the speaker 6, and visible, on the display 4. The speaker 6 and the display 4 therefore together act as an alarm device. The display 4 shows, as depicted in FIG. 1, both the range and the bearing to the tag, the bearing being indicated by an arrow (in a compass-like display) pointing in the appropriate direction.

In an alternative, or additionally, the display may display a map showing the location of the tag, and optionally the mobile telephone. The map may be a graphic map, or may be photographic, such as that provided by Google® Maps. A real-time updated map is preferred, so that the current circumstances of the tag, and so of the object which the tag is guarding, can be seen on the display on the mobile telephone.

The speaker 6 may emit regular sounds or beeps, the speed at which the beeps are emitted indicating the range to the tag 2. As such, the beeps may speed up the closer the mobile telephone 1 is to the tag 2. The range to the tag 2 can be indicated numerically on screen, typically counting down in five meter intervals.

On the issuance of an alarm, the user can be provided with the option to “sleep” the alarm; that is, the alarm can be suppressed for a predetermined period (say one minute). This is useful where it is known that the tagged object (for example, a child) is safe despite being outside the range. The sleeping of the alarm will provide a prompt to regularly check upon the tagged object. As such, when the tag 2 goes outside the predetermined range, the user may be presented with a “sleep” option, which functions as described above, and a “search” option, which displays the range and bearing to the tag 2.

Additionally or alternatively, the mobile telephone 1 can be programmed such that the range processing circuit 12 (which, as will be recalled, can be the or a general purpose microprocessor handling the general functions of the mobile telephone 1) runs a pre-selected application on the issuance of an alarm. This application could be used to send a message (the message therefore forming part of the alarm) of some kind. Examples of such messages include text messages using the short messaging service (SMS), picture messages using the multimedia messaging service (MMS) or the placement of a voice telephone call.

An application could additionally (or alternatively) record sound or video in the vicinity of the mobile telephone 1. This latter functionality is also useful if the mobile telephone is provided with a panic button, which can cause the mobile phone to record that which is occurring nearby, and possibly also send messages, such as messaging asking for help.

Additionally, the tag 2 may be arranged to record sound or video and to transmit the same back to the mobile telephone 1 in case of an alarm; the video received or captured at the mobile telephone can then be displayed on the display 4 or transmitted elsewhere using the telecommunications features of the mobile telephone 2. Accordingly, a record or display can be made of what is potentially happening to the tagged object or person. The transmission of video or sound from the tag 2 to the handset could be through any of GSM, GPRS, WiFi or Bluetooth or any other radio telecommunications technology.

In order to determine the range, the range calculation circuit can function in a number of ways. The receiver 10 could monitor the power of the received signal, and assume that the tag 2 transmits at a constant power and that the power received by the receiver 10 decreases with range as an inverse square law. Alternatively, the receiver 10 could itself transmit signals to the tag 2; the tag transmitter 7 could receive these signals and rebroadcast them. By listening from the returned signal and comparing the received signal to that transmitted, the range calculation circuit 12 can determine the range by comparing the time of flight for the return trip, or by comparing the phase difference between the transmitted and received signals.

In order to determine the bearing of the tag 2 relative to the mobile telephone 1, the auxiliary antenna 9 is a phased array, comprising multiple sub-antennas. By comparing the relative phases and amplitudes of the received signals from the different antennas, the range calculation circuit 12 can determine the bearing of the tag 2.

Additionally or alternatively, mobile telephone 1 and the tag 2 both comprise Global Positioning System (GPS) sensors 15, 16. These determine the location of each component relative to a worldwide datum. The tag transmitter 7 can therefore transmit the tag position data in the signal to the mobile telephone 1; the range calculation circuit will also determine the position of the mobile telephone 1 and compare that with the tag position data, to determine the relative positions (range and bearing) of the tag 2 relative to the mobile telephone. Whilst GPS has limitations on its accuracy, some of these inaccuracies tend to manifest as a constant offset over the distances involved in the present invention. By measuring the GPS position of the tag 2 and the mobile telephone 1, the offset will be removed, thus improving the accuracy of a single GPS measurement.

In such a case, rather than employing a local transmitter 7-receiver 10 pair, the tag can be provided with a mobile data telecommunications link (for example, via GSM) by means of which it can communicate with the mobile telephone 1 (which will have an equivalent data communications capability) to transmit the signal carrying the location data.

If local transmission is used, the transmitter 7 and receiver 10 form a Personal Area Network, conveniently according to the Bluetooth standard, as is commonly found on mobile telephones. The mobile telephone may be linkable to multiple tags; each tag may therefore carry its own distinct identification code. As is common with the Bluetooth standard, each tag 2 may be paired with the mobile telephone 1.

Conveniently, where a Bluetooth transmitter 7 and a GPS sensor 16 are used, they can be implemented on one chip, such as the BlueCore7-FM available from CSR plc, Cambridge, United Kingdom. Alternative suitable transmitters 7 include the BlueCore 4 or 5 chips also available from CSR plc, which have conveniently low footprint. Conveniently, Bluetooth Low Energy can be used, to reduce power consumption and to increase the depth of field available to up to 150 metres.

A user can demand, through input buttons 5, that the range calculation circuit cause to be displayed on the display 4 the position (range and bearing) of the tag 2. This allows the position of the tag to be tracked by the user even if an alarm is not being emitted. This is useful, for example, if the user cannot find their tagged keys. Similarly, the tag may be provided with an input device, such as a button, by means of which the tag will cause the range calculation to cause to be displayed on the display 4 the position (range and bearing) of the tag 2, as well as sounding an alarm. This is useful if the mobile telephone 1 cannot temporarily be found.

As part of the transmitted signal, the tag 2 can include an indication of a fault condition; for example, if the battery 8 is running low, if someone has attempted to access the inside of the body of the tag 2 (that is, tampering has occurred) or if the tag has been removed from the object that it is guarding. In the latter two cases, microswitches may be provided that provide an indication that the tag body is closed and that the tag is still appropriately attached.

Should the received signal from the tag 2 at the mobile telephone 1 indicate that a fault condition occurs, the audible and visible alarm may be raised by the range calculating circuit 12.

The functionality provided by this embodiment is conveniently downloadable to the mobile telephone, thus providing a simple way of upgrading a standard mobile telephone to provide the present functionality.

Where the tag 2 is attached to the user of the mobile telephone 1, the functions of the mobile telecommunications device may be locked or severely restricted in case of an alarm. This means that, unless the tagged user is in the locality of the mobile telephone 1, the mobile telephone 2 cannot be used. This is particularly useful where the mobile telephone 1 is a mobile computer, or rugged mobile device, as this will prevent unauthorised access to potentially sensitive data contained in the mobile telephone 2. Indeed, the mobile telephone may be arranged to copy particularly sensitive data off the device (using its telecommunication functions) or to delete such data (or both sequentially) when the alarm sounds, to prevent the data being compromised.

Where a computer is tagged, for example by forming the tag 2 as a USB stick inserted into a USB port of the computer, the tag 2 can act to lock the computer should the alarm indicate that the mobile telephone has moved out of range.

Multiple tags 2 can be monitored by a single mobile telephone 1; in such a case each tag would generally be assigned an individual name, which can be displayed should an alarm occur with respect to that tag 2.

Giving each tag a unique identifier, and the ability to store other data, is useful where items such as suitcases are being tagged, for identification purposes. Suitcases in particular can be tagged before a user checks in their baggage into the hold of an aircraft; when waiting at baggage reclaim, the mobile telephone 2 may be able to indicate when their baggage is approaching, thus avoiding unruly scrums at the baggage retrieval carousel.

Especially where multiple tags are employed, each tag 2 may be able to receive and transmit sound; as such, the tags can communicate data, typically sound and/or video, between themselves and the mobile telephone 1. Each tag 2 can then be used as a speakerphone, or to communicate with the other tags 2 or with the mobile telephone 1.

The alarm of this embodiment could be used to enforce “digital fences”, whereby the tag 2 is attached to an item of value (for example, a power tool) that is not permitted to be taken outside of a given area surrounded by a virtual fence delimiting the area; the mobile telephone 1 can enforce this virtual fence.

1. A separation alarm, comprising a mobile telecommunication device and a tag; the mobile telecommunication device comprising:
a receiver, which is able to receive signals transmitted by the tag;
a range calculator, which is able to determine, from the signals received from the tag, the range of the tag from the mobile telecommunication device to generate a range signal, and compare the range to a predetermined range limit;
and an alarm device, arranged to emit an alarm on instruction by the range calculator;
the tag comprising a transmitter arranged to transmit signals to the mobile telecommunication device;
in which the range calculator is arranged to cause the alarm device to emit an alarm should the range indicated by the range signal exceed the range limit,
in which a device selected from a group comprising the mobile telecommunications device and the tag is arranged to capture or cause to be captured as part of the alarm being emitted, sound or video occurring in its vicinity.

2. The separation alarm of claim 1, in which the device is the tag and is arranged to transmit the sound or video to the mobile telecommunications device.

3. The separation alarm of claim 1, in which the mobile telecommunications device is arranged to transmit the sound or video using mobile telecommunications functions of the mobile telecommunications device.

4. The separation alarm of claim 1, in which the range calculator is arranged to determine, from the signals transmitted by the tag, the bearing of the tag relative to the mobile telecommunication device.

5. The separation alarm of claim 1, in which the mobile telecommunications device and the tag are each provided with a location determination device, arranged to determine the position of the mobile telecommunication device and the tag respectively.

6. The separation alarm of claim 5, in which the tag is arranged to determine its position using its location determination device and to transmit in the signals its position, with the range determination device arranged to compare the position of the tag as received in the signals with the position of the mobile telecommunication device as determined from its location determination device in order to determine the range of the tag relative to the mobile telecommunication device.

7. The separation alarm of claim 4, in which the mobile telecommunication device is provided with an output for providing information to the user, in which the range calculator is arranged to cause the output to output a bearing of the tag relative to the mobile telecommunication device in which the output comprises a visual display, the mobile telecommunication device being arranged to display the current location of the tag on the visual display.

8. (canceled)

9. The separation alarm of claim 7, in which the mobile telecommunication device is arranged to show, on the display, the location of the tag by indicating the range and bearing of the tag.

10. The separation alarm of claim 1, in which the range calculator is arranged to cause the alarm device to emit an alarm should the signals from the tag not be received.

11. The separation alarm of claim 1, in which the tag is arranged to indicate, in the signals transmitted by it, whether a fault condition exists in the tag, the range calculator being arranged to cause the alarm device to emit an alarm should the signals received from the tag indicate a fault condition.

12. (canceled)

13. The separation alarm of claim 1, in which the mobile telecommunication device comprises a tag transmitter, whereby a query signal can be sent to the tag, the tag being arranged to rebroadcast the query signal in the signal transmitted by the tag, the range calculator typically being arranged to determine the range of the tag from the mobile telecommunication device by determining the time of flight or phase change of the query and received signals.

14. (canceled)

15. The separation alarm of claim 1, in which the signals transmitted by the tag and received by the mobile telecommunication device are according to a personal area network.

16. The separation alarm of claim 1, in which the tag comprises an input device such that activation of the button causes the tag to send in the signals a signal to the mobile telecommunication device so as to cause the range processor circuit to cause the alarm device to emit an alarm.

17. The separation alarm of claim 1, in which the alarm device is arranged to run an application on the mobile telecommunications device in order to emit an alarm.

18. The separation alarm of claim 17, in which the application is arranged to send a message using telecommunications features of the mobile telecommunications devices.

19. The separation alarm of claim 1, in which the mobile telecommunications device has user functions engagable by a user using a user interface, the mobile telecommunications device being arranged such that access to at least some of the user functions is blocked should an alarm be emitted.

20. The separation alarm of claim 19, in which the mobile telecommunications device is arranged so that data stored on the device is copied off the device to a remote location using mobile telecommunications functions of the mobile telecommunications device, then preferably deleted from the device, should an alarm be emitted.

21. A mobile telecommunication device comprising:
a receiver, which is able to receive signals transmitted by a tag;
a range calculator, which is able to determine, from the signals received from the tag, the range of the tag from the mobile telecommunication device to generate a range signal;
and an alarm device, arranged to emit an alarm on instruction by the range calculator;
in which the range calculator is arranged to cause the alarm device to emit an alarm should the range indicated by the range signal exceed the range limit; and
in which the mobile telecommunications device is arranged to cause the tag to capture, as part of the alarm being emitted, sound or video occurring a vicinity of the tag, and to receive the sound or video.

22-24. (canceled)

25. An article of manufacture comprising a computer-readable medium storing programming configured to cause processing circuitry of a mobile telecommunication device to perform processing comprising:
receiving signals transmitted by a tag;
calculating, from the signals received from the tag, a range of the tag from the mobile telecommunication device;
emitting an alarm should the range indicated by the range signal exceed a range limit;
causing the tag to capture, as part of the alarm being emitted, sound or video occurring in a vicinity of the tag,
and receiving the sound or video.

26. A method of alerting a user to the separation of a mobile telecommunication device and a tag, comprising:
receiving, at the mobile telecommunications device, signals transmitted by the tag;
determining, from the signals received from the tag, the range of the tag from the mobile telecommunication device,
comparing the range to a predetermined range limit;
emitting an alarm on instruction should the range indicated by the range signal exceed the range limit, and
capturing, as part of the alarm being emitted, sound or video occurring in its vicinity of a device selected from a group comprising the mobile telecommunications device and the tag.
